(19) United States
(12) Patent Application Publication
(10) Pub. No.: US 2007/0180656 A1
(43) Pub. Date: Aug. 9, 2007

(54) HINGE HAVING THE FUNCTION OF AUTO-SHUTTING

(76) Inventors: Chia-Hui CHEN, Kwei Shan Hsiang (TW); Tien-Yueh Hsu, Kwei Shan Hsiang (TW)

Correspondence Address: SINORICA, LLC, 528 FALLSGROVE DRIVE, ROCKVILLE, MD, 20850, US

(21) Appl. No.: 11/620,837

(22) Filed: Jan. 8, 2007

(30) Foreign Application Priority Data
Feb. 9, 2006 (TW) 095202269

(51) Int. Cl. E05D 11/08

(52) U.S. Cl. 16/340

(57) ABSTRACT

A hinge having the function of auto-shutting, it is formed on a rotation axle thereof a pair of engaging structures being of different sizes, being composed of a pair of protrusions and a pair of detents as well as being at mutual symmetrical positions separated 180° away on contact surfaces of a positioning device including a positioning block and a positioning piece, in order that a foldable electronic product connected with the hinge is able to shut automatically when in folding. And a pair of protruding stubs and recess holes are provided at the two lateral sides of the smaller protrusion and the smaller detent of the engaging structures, in order to prevent the smaller protrusion from falling into the larger detent when the foldable electronic product is opened.

### BACKGROUND OF THE INVENTION

1. Field of the Invention

The present invention relates to a hinge having the function of auto-shutting, and especially to a hinge used in a foldable electronic product and being able to shut automatically when in folding.

2. Description of the Prior Art

A foldable electronic product such as a notebook, is composed of a main body and a screen foldable on the main body; the folding function is achieved by providing a hinge between the two components.

By the fact that notebooks are required to be miniaturized and for wireless communication, and are required to have their costs of production and sized reduced, latch devices used for folding display screens on main bodies are often asked to be saved in order that multiple wireless receivers can be mounted on the front edges of the display screens. The cases that latch devices are saved for notebooks normally are called “latchless” or “autolock”, they have an advantage of reducing the requirement of maintenance for the damaged latch devices. However, in such a latchless situation, a hinge must be provided with a function of auto-shutting, in order that in folding of a display screen on a main body, no natural opening will happen, but the display screen opened can be positioned at any angular position.

Such a hinge with the function of auto-shutting in the prior art is composed of a positioning block not rotating together with the rotation shaft of the hinge and a positioning piece, contact surfaces for the positioning block and the positioning piece are provided with a pair of protruding and recessed engaging structures of different sizes in order to get the function of auto-shutting.

For example, a U.S. Pat. No. 6,862,779 with a date of patent of Mar. 8, 2005 and titled as “HINGE WITH AN ANTI-BUMP FEATURE” discloses a hinge; the hinge has a rotating positioning element having thereon a round hole which has therearound detents; and has a stationary positioning element having a central through hole, the stationary positioning element is provided with protrusions in correspondence by position with the detents of the rotating positioning element; and has a pivot pin of which one end is a combination shaft which is extended sequentially through a washer, the rotating positioning element, the stationary positioning element and a biasing member. The pivot pin is fixed on a base of a portable computer, the rotating positioning element is fixed on a cover of the computer; by engaging of the dents with the protrusions, the cover can get an effect of positioning during closing of it to the base. Such a design makes the computer get an effect of positioning during closing the cover, and have no effect of positioning during opening the cover.

According to the foregoing conventional patent, the first dent and the second dent on the rotating positioning element are designed to be located at positions not mutual opposite diametrically of a central circular hole, the centerlines respectively of the rotating positioning element and the stationary positioning element intersect at an angle which is not equal to 180°, and the distance of the first dent to the center of the central circular hole is not equal to that of the second dent to the center of the central circular hole. By such designing, the smaller protrusion on the rotating positioning element will not fall into the larger protrusion on the stationary positioning element during opening of the cover. However, in this foregoing conventional patent, by virtue that the distances respectively of the first dent and the second dent to the center of the central circular hole are not equal, twisting force born by the protrusions will be different when the protrusions are contacted with the friction surfaces of the rotating positioning element, thus the protrusions are subjected to being damaged, and improvement is wanted. Further, by the fact that the protrusions and the dents are located asymmetrically with each other on the rotating positioning element and the stationary positioning element respectively, the contact areas are small, and stresses are concentrated on the protrusions, this can reduce the life of use of the hinge.

### SUMMARY OF THE INVENTION

The present invention provides an improvement on the conventional hinge having a function of auto-shutting, it is mainly to form on a rotation axle of a hinge a pair of engaging structures being of different sizes, being composed of a pair of protrusions and a pair of detents as well as being at mutual symmetrical positions separated 180° away on contact surfaces of a positioning device including a positioning block and a positioning piece, in order that a foldable electronic product connected with the present invention is able to shut automatically when in folding. And a pair of protruding stubs and recess holes are provided at the two lateral sides respectively of the smaller protrusion and the smaller detent of the engaging structures, in order to prevent the smaller protrusion from falling into the larger detent when the foldable electronic product is opened. By virtue that the two engaging structures are at mutual symmetrical positions, and the positioning block and the positioning piece have the same distance to a respective center of the corresponding one of their central holes, there will be no problem of offset of location diametrically, thus the areas of the protrusions and the detents can be increased, and thus their contact areas can also be larger, this can get an effect of scattering stresses, twisting force born by the engaging structures having on their friction surfaces the protrusions and the detents can be even to thereby reduce wearing, this can prolong the life of use of the hinge.

The hinge of the present invention has the function of auto-shutting, when it is used in a foldable electronic product, no more latching device is needed, and the problem of engaging and alignment or mating resulted by the latching device will not happen.

The present invention will be apparent in its structural feature and effects of operation after reading the detailed description of the preferred embodiment thereof in reference to the accompanying drawings.

### BRIEF DESCRIPTION OF THE DRAWINGS

FIG. 1 is a perspective view of the present invention after assembling;

FIG. 2 is an anatomic perspective view of the present invention;

FIG. 3 is a plane view of the present invention;

FIG. 4 is a sectional view taken from a sectional line 4-4 in FIG. 3;

FIG. 5 is an enlarged perspective view showing a positioning block and a positioning piece of the present invention;

FIG. 6 is a plane view of the positioning block of the present invention;

FIG. 7 is a plane view of the positioning piece of the present invention;

FIG. 8 is an anatomic perspective view of a second embodiment of the present invention;

FIG. 9 is an anatomic perspective view of a third embodiment of the present invention;

FIG. 10 is an anatomic perspective view of a fourth embodiment of the present invention.

### DETAILED DESCRIPTION OF THE PREFERRED EMBODIMENT

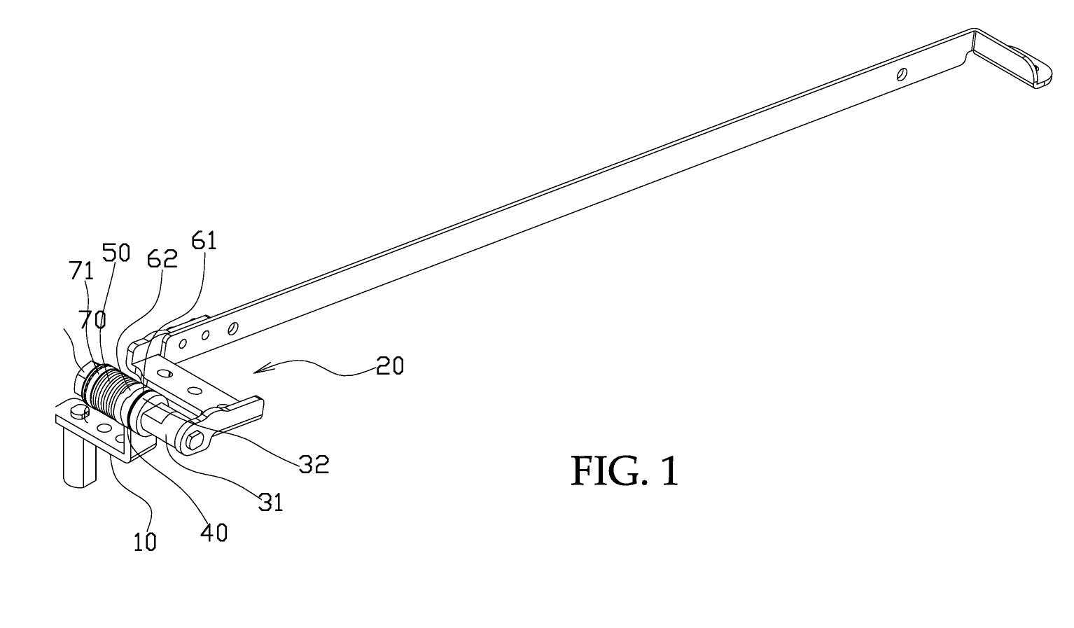

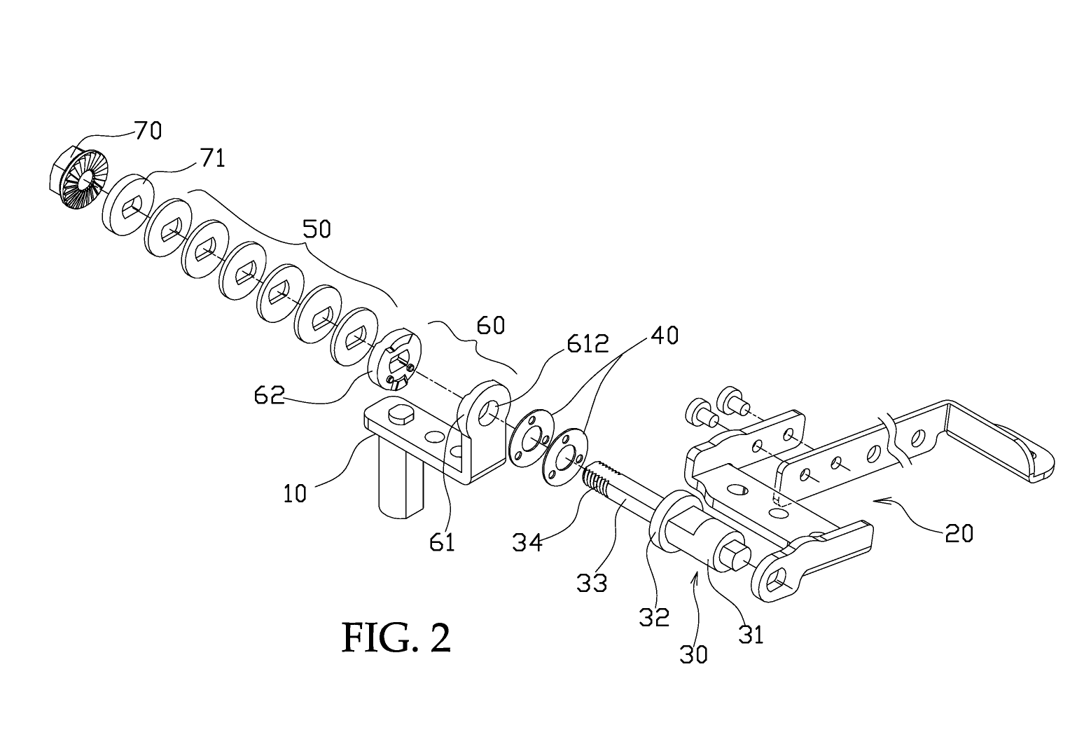

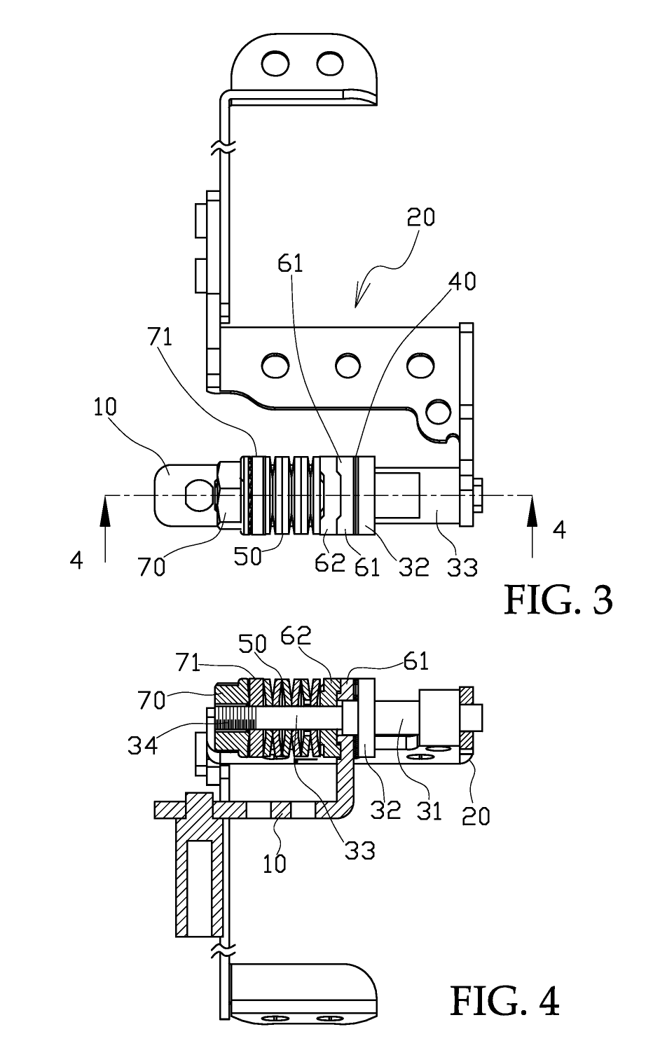

Referring to FIGS. 1 to 3 showing a first embodiment of the present invention, wherein a hinge of the present invention has a base 10 fixed in a foldable electronic product, and a bracing structure 20 fixedly connected with a display screen of the foldable electronic product. A rotation axle 30 having a connecting part 31 connected with the bracing structure 20, a middle wheel 32 and a shank 33 of the rotation axle 30 extending through a central circular hole 612 of a positioning block 61 on the base 10. The top and the bottom of the rotation axle 30 are cut to form planes. There are a plurality of washers 40, a spring washer set 50 and a positioning device 60 composed of the positioning block 61 and a positioning piece 62; a threaded portion 34 on the tailing end of the shank 33 is extended through a positioning washer 71 and screw connected with a nut 70 to mount all the above members on the base 10. In this embodiment, the positioning block 61 is integrally connected with the base 10 to form a fixing member. With this structure, the spring washer set 50 provides pressing force, in order that the bracing structure 20 to be fixedly connected with the display screen of the foldable electronic product can be folded to a main body of the foldable electronic product or folded to any angular angle in an open state. The nut 70 can adjust the pressing force of the spring washer set 50 to adjust the twisting force on the hinge. The washers 40 are provided between the middle wheel 32 and the positioning block 61.

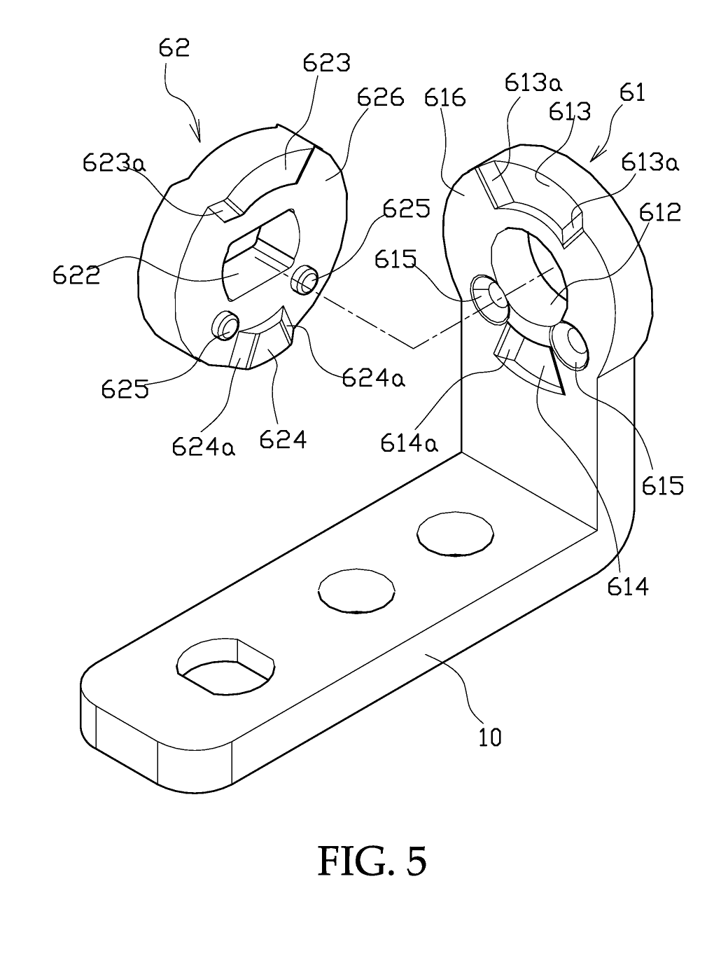

The main improvement of the present invention is resided in the positioning device 60 disclosed in cooperation with FIGS. 4 and 5.

The positioning block 61 is connected with the base 10 therebelow; by virtue that the diameter of the central circular hole 612 of the positioning block 61 is larger than that of the shank 33 of the rotation axle 30, the positioning block 61 is not rotated together with the rotation axle 30. A contact surface 616 of the positioning block 61 is formed thereon a larger dent 613 and a smaller dent 614; the smaller dent 614 is provided at its two lateral sides each with a recess hole 615. The two dents 613, 614 on the positioning block 61 are designed to have each on its lateral sides bevel surfaces 613a and 614a.

A central through hole 622 of the positioning piece 62 has a shape in coincidence with the shape of a transverse sectional area of the shank 33 of the rotation axle 30, in order that the positioning piece 62 is rotated together with the rotation axle 30. A contact surface 626 of the positioning piece 62 is formed thereon a larger protrusion 623 and a smaller protrusion 624; the smaller protrusion 624 is provided at its two lateral sides each with a protruding stub 625. The two recess holes 623, 624 on the positioning piece 62 are designed to have each on its lateral sides bevel surfaces 623a and 624a.

The larger dent 613 and the smaller dent 614 on the positioning block 61 are mated respectively with the larger protrusion 623 and the smaller protrusion 624 to form respectively a larger and a smaller engaging structure. Wherein the protrusions 623 and 624 of the positioning piece 62 will move on the contact surface 616 of the positioning block 61 during rotation of the rotation axle 30; and the protrusions 623 and 624 will be exactly engaged in the dents 613 and 614 when the screen and the main body of the foldable electronic equipment are at folded positions to form the function of auto-shutting.

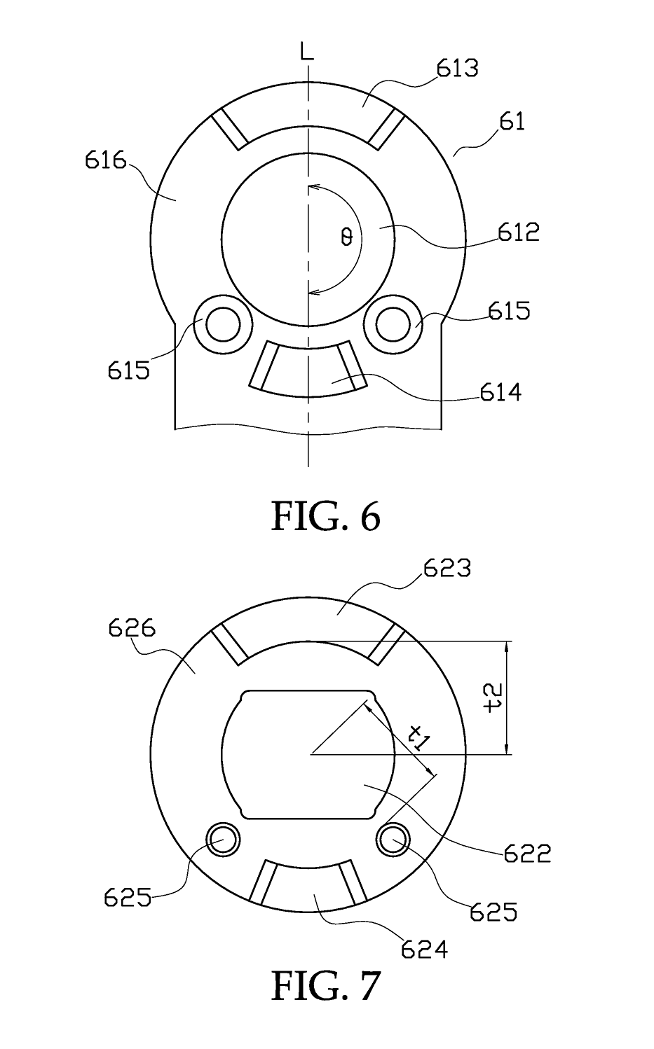

Referring to FIG. 6, the center lines of the larger dent 613 and the smaller dent 614 on the positioning block 61 meet together to form a line “L”, which two lines intersect at an angle of 180° (the angle θ in FIG. 6), and these two have the same distance to the center of the central circular hole 612. Such designing means that the larger and the smaller engaging structures are mutual symmetrical by position, there is no restraining of asymmetry, the contact areas of them can be increased, distribution of stresses can be even during engaging of the larger protrusion 623 and the smaller protrusion 624 of the positioning piece 62 in the larger dent 613 and the smaller dent 614 respectively; and the twisting forces born by the two engaging structures are nearly equal, they are not subjected to being damaged in long term using.

And more, please refer to FIG. 7, the center of each of the two protruding stubs 625 has a distance t1 to the center of the central through hole 622 of the positioning piece 62 being not larger than a distance t2 from an inner edge of the larger protrusion 623 to the center of the central through hole 622. The object of such designing of the protruding stubs 625 aims at that, the surfaces of the protruding stubs 625 as well as of the larger and the smaller protrusions 623, 624 will move on the contact surface 616 of the positioning block 61; and by supporting of the protruding stubs 625 during opening the display screen of the foldable electronic product relatively to the main body to an angle of 180°, the smaller protrusion 624 can be prevented from falling into the larger detent 613.

Evidently, the designing for the present invention renders the hinge to have the function of auto-shutting, and the larger and the smaller engaging structures bear more even twisting forces, and their contact areas are increased to be not subjected to being damaged.

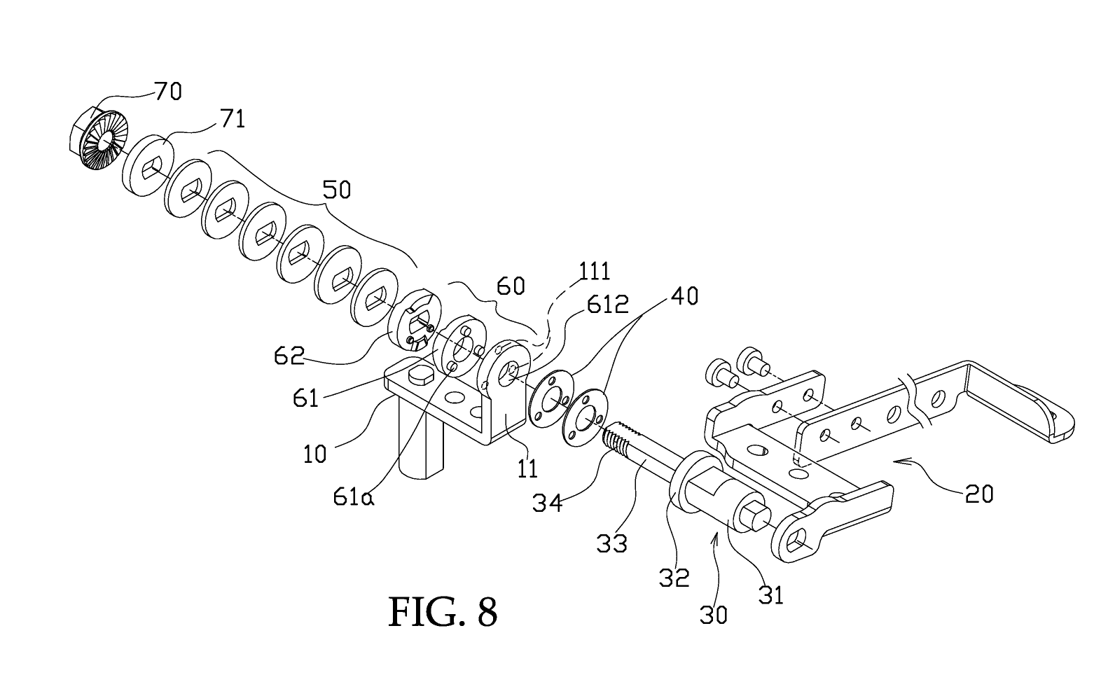

Moreover, when the base 10 is made of soft material, the positioning block 61 can be made of hard material to allow it to be designed in a separated state. Referring to FIG. 8 showing a second embodiment of the present invention, wherein the contact surface 616 of the positioning block 61 for contacting a vertical part 11 of the base 10 is provided with three protruding stubs 61a, and the vertical part 11 of the base 10 for extending therethrough of the shank 33 of the rotation axle 30 is correspondingly provided with three recess holes 111, by engaging of the protruding stubs 61a with the recess holes 111, the positioning block 61 can be fixed on the vertical part 11 of the base 10. The remaining parts of the second embodiment are same as those of the first embodiment.

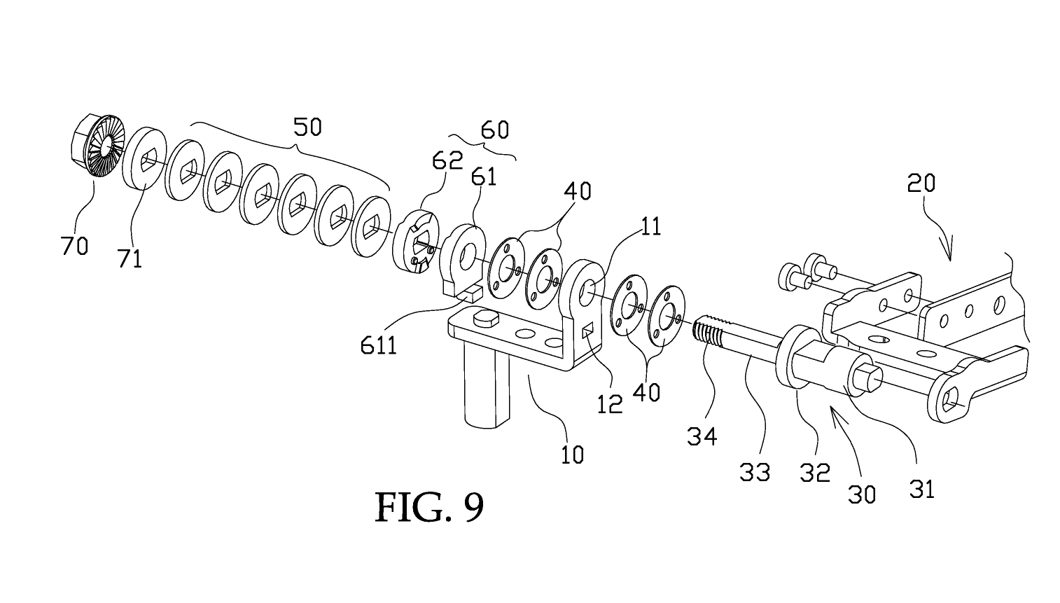

Further, referring to FIG. 9 showing a third embodiment of the present invention, wherein the positioning block 61 can be designed to be an “L” shaped structure having an engaging seat 611 therebeneath, the engaging seat 611 is extended into a rectangular hole 12 on the vertical part 11 of the base 10, and another set of washers 40 are provided between the vertical part 11 and the positioning block 61. The remaining parts of the third embodiment are same as those of the first embodiment. By this designing, the embodiment has one more friction function provided by the additional set of washers 40 as compared with the second embodiment.

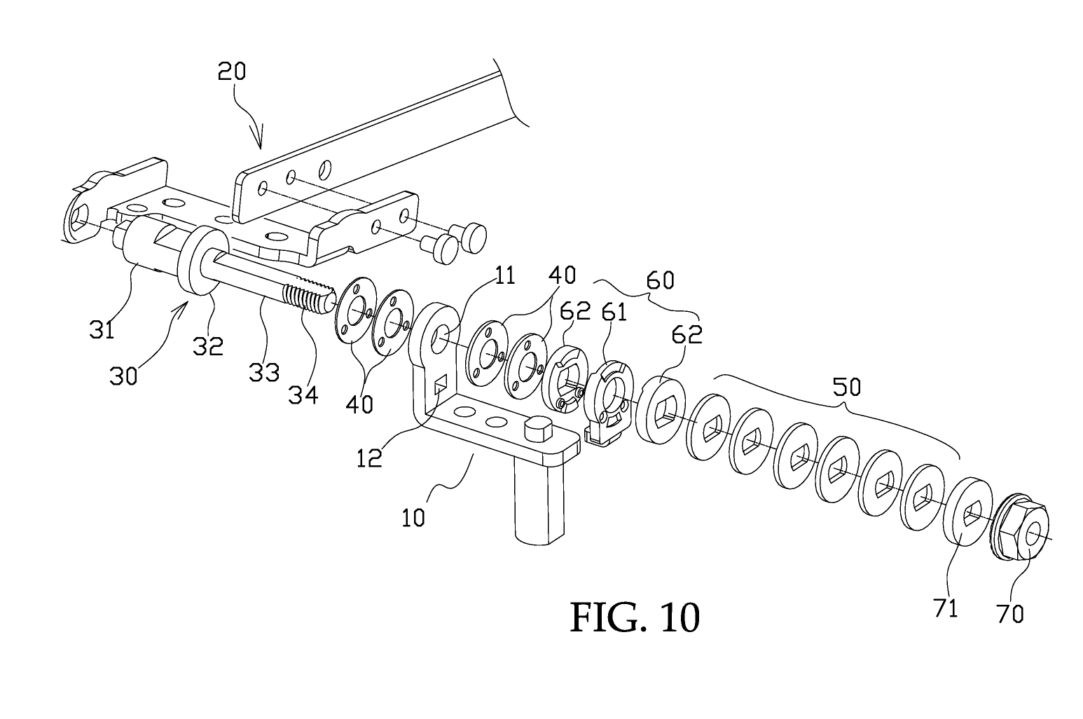

And more, referring to FIG. 10 showing a fourth embodiment of the present invention, as compared with the third embodiment shown in FIG. 9, both left and right sides of the positioning block 61 are designed to have each dents and recess holes, and both left and right sides of the positioning block 61 are provided each with a positioning piece 62; while the other set of washers 40 are provided between the vertical part 11 and the positioning piece 62 near the vertical part 11. The remaining parts of the embodiment are same as those of the third embodiment. The object of such designing is to make the function of auto-shutting more evident by the actions of the positioning piece 62 and the positioning block 61.

Having thus described the technical structure of my invention with practicability and improvement, what I claim as new and desire to be secured by Letters Patent of the United States is:

1. A hinge having a function of auto-shutting used between a display screen and a main body of a foldable electronic product, said hinge comprises:
a base fixed in said foldable electronic product;
a bracing structure fixedly connected with a display screen of said foldable electronic product;
a rotation axle having a connecting part connected with said bracing structure and a shank extending through a central circular hole of said base;
a spring washer set provided on said shank of said rotation axle to provide pressing force; and
a positioning device provided on said shank of said rotation axle, being composed of a positioning block connected with said base and not rotated together with said rotation axle; and a positioning piece rotated together with said rotation axle; contact surfaces for said positioning block and said positioning piece being provided with a pair of protruding and recessed engaging structures of different sizes mutual symmetrical by position and composed of a pair of protrusions and a pair of detents, said hinge thus having said function of auto-shutting during folding of said foldable electronic product in connection with said hinge; a pair of protruding stubs and recess holes are provided at two lateral sides respectively on said positioning block and said positioning piece of said smaller one of said two engaging structures, said protruding stubs and recess holes are mutually engaged when said protrusions and said detents are mutually engaged; centers of said protruding stubs has a distance to a central through hole of said positioning piece which is not larger than a distance from an inner edge of a larger one of said protrusions to said center of said central through hole, this prevents a smaller one of said protrusions from falling into a larger one of said detents during opening said foldable electronic product.

2. The hinge having a function of auto-shutting as claimed in claim 1, wherein said protrusions of said engaging structures are provided on said contact surface for said positioning piece, while said detents are provided on said contact surface for said positioning block.

3. The hinge having a function of auto-shutting as claimed in claim 1, wherein said positioning block is integrally connected with said base, a diameter of a central circular hole of said positioning block is larger than that of said shank of said rotation axle, so that said positioning block is not rotated together with said rotation axle.

4. The hinge having a function of auto-shutting as claimed in claim 1, wherein said positioning block is separated from said base, said base has a vertical part extending therethrough said shank of said rotation axle, said positioning block is provided on one of said contact surfaces in contact with said vertical part of said base with three protruding stubs, while said vertical part of said base is correspondingly provided with three recess holes, by engaging of said protruding stubs with said recess holes, said positioning block is fixed on said vertical part of said base.

5. The hinge having a function of auto-shutting as claimed in claim 1, wherein said positioning block is an “L” shaped structure having an engaging seat therebeneath, said engaging seat is extended into a rectangular hole on a vertical part of said base.

6. The hinge having a function of auto-shutting as claimed in claim 5, wherein another set of washers are provided between said vertical part of said base and said positioning block.

7. The hinge having a function of auto-shutting as claimed in claim 5, wherein both left and right sides of said positioning block each has dents and recess holes, and both said left and right sides of said positioning block are provided each with a positioning piece.

8. The hinge having a function of auto-shutting as claimed in claim 7, wherein another set of washers are provided between said vertical part and said positioning piece near said vertical part.

9. The hinge having a function of auto-shutting as claimed in claim 1, wherein a threaded portion is provided on a tailing end of said shank and is screw connected with a nut, a positioning washer is provided between said nut and a spring washer set.

10. The hinge having a function of auto-shutting as claimed in claim 1, wherein a top and a bottom of said rotation axle are cut to form planes, said central through hole of said positioning piece has a shape in coincidence with a shape of a transverse sectional area of said shank of said rotation axle for said shank to extend therethrough, in order that said positioning piece is rotated together with said rotation axle.

11. The hinge having a function of auto-shutting as claimed in claim 1, wherein a middle wheel is provided between said shank and said connecting part of said rotation axle, washers are provided between said middle wheel and said positioning block.
